(19) United States
(12) Patent Application Publication
(10) Pub. No.: US 2013/0215451 A1
(43) Pub. Date: Aug. 22, 2013

(54) METHOD AND APPARATUS FOR AUTOMATICALLY DETECTING PAGE DESCRIPTION LANGUAGES SUPPORTED BY IMAGE PRODUCTION DEVICES

(71) Applicants: Jason C. TSONGAS, Rochester, NY (US); Matthew O. Scrafford, Fairport, NY (US); Lynn Marie Bell, Fairport, NY (US)

(72) Inventors: Jason C. TSONGAS, Rochester, NY (US); Matthew O. Scrafford, Fairport, NY (US); Lynn Marie Bell, Fairport, NY (US)

(73) Assignee: XEROX CORPORATION, Norwalk, CT (US)

(21) Appl. No.: 13/398,459

(22) Filed: Feb. 16, 2012

(51) Int. Cl. G06K 15/02

(52) U.S. Cl. 358/1.15

(57) ABSTRACT

A method for automatically detecting page description languages supported by image production devices in an image production device network may include receiving a print job for printing, determining which page description languages are supported by each image production device in the image production device network, determining if the print job's page description language is supported by one or more image production devices in the image production device network. If the print job's page description language is supported, the print job is printed at one of the one or more image production devices using the print jobs page description language. If the print job's page description language is not supported, the print job is converted to a page description language supported by one of the one or more image production devices, and printed at the one of the one or more image production devices using the supported page description language.

### BACKGROUND

Disclosed herein is a method for automatically detecting page description languages supported by image production devices, as well as corresponding apparatus and computer-readable medium.

In conventional image production device networks, when a system is submitting a job to an image production device, such as a printer, the system must know which PDLs (Page Description Language) the image production device supports before generating the PDL for the device. In conventional image production devices, the PDL must be defined in advance of a print job and must be set for every image production device in which the system will interact. Device changes, such as adding PDLs, require modifications to settings to take advantage of the new PDL which adds time and complexity to the process.

### SUMMARY

A method and apparatus for automatically detecting page description languages supported by image production devices is disclosed. The method may include receiving a print job for printing, determining which page description languages are supported by each image production device in the image production device network, determining if the print job's page description language is supported by one or more image production devices in the image production device network. If the print job's page description language is supported, the print job is printed at one of the one or more image production devices using the print jobs page description language. If the print job's page description language is not supported, the print job is converted to a page description language supported by one of the one or more image production devices, and printed at the one of the one or more image production devices using the supported page description language.

### BRIEF DESCRIPTION OF THE DRAWINGS

FIG. 1 is an exemplary diagram of an image production device network in accordance with one possible embodiment of the disclosure;

FIG. 2 is an exemplary block diagram of the image production device management server in accordance with one possible embodiment of the disclosure; and

FIG. 3 is a flowchart of an exemplary automatic page description languages detection process in accordance with one possible embodiment of the disclosure.

### DETAILED DESCRIPTION

Aspects of the embodiments disclosed herein relate to a method for automatically detecting page description languages supported by image production devices, as well as corresponding apparatus and computer-readable medium.

The disclosed embodiments may include a method for automatically detecting page description languages supported by image production devices. The method may include receiving a print job for printing, determining which page description languages are supported by each image production device in the image production device network, determining if the print job's page description language is supported by one or more image production devices in the image production device network. If the print job's page description language is supported, the print job is printed at one of the one or more image production devices using the print jobs page description language. If the print job's page description language is not supported, the print job is converted to a page description language supported by one of the one or more image production devices, and printed at the one of the one or more image production devices using the supported page description language.

The disclosed embodiments may further include an image production device management server that automatically detects page description languages supported by image production devices in an image production device network, that may include a communication interface, and a page description language management unit that receives a print job for printing through the communication interface, determines which page description languages are supported by each image production device in the image production device network, determines if the print job's page description language is supported by one or more image production devices in the image production device network, wherein if the print job's page description language is supported by one or more image production devices in the image production device network, the page description language management unit prints the print job at one of the one or more image production devices using the print jobs page description language, wherein if the print job's page description language is not supported by one or more image production devices in the image production device network, the page description language management unit converts the print job to a page description language supported by one of the one or more image production devices, and prints the print job at the one of the one or more image production devices using the supported page description language.

The disclosed embodiments may include a non-transient computer-readable medium storing instructions for controlling a computing device for automatically detecting page description languages supported by image production devices. The instructions may include receiving a print job for printing, determining which page description languages are supported by each image production device in the image production device network, determining if the print job's page description language is supported by one or more image production devices in the image production device network. If the print job's page description language is supported, the print job is printed at one of the one or more image production devices using the print jobs page description language. If the print job's page description language is not supported, the print job is converted to a page description language supported by one of the one or more image production devices, and printed at the one of the one or more image production devices using the supported page description language.

The disclosed embodiments may concern automatically detecting page description languages supported by image production devices. In particular, the disclosed embodiments may provide for an instance where the user submits an image production device job to an image production device management server which may detect the Page Description Language (PDL) that the device supports and take the appropriate action based on the document submitted by a user for processing. If the document is in a format that the image production device can accept directly, the image production device management server may send the document directly to the image production device and may not be converted to a PDL. If the file type cannot be accepted by the image production device it may be converted into the appropriate PDL before being delivered to the image production device. Updates to the accepted device PDLs may be detected automatically and become available.

The image production device management server may query each printer and retrieve the information from the printer to determine which PDLs the printer supports. The image production device management server may retrieve the description and version of the document to determine what is the best fit PDL to use. Once the description and version has been determined, the image production device management server or other device or application in contact with the image production device management server application, may use the information to determine how to process the image production device job before sending it to the image production device. As many image production devices support native document types like PDF, XPS, or TIFF, the image production device will determine if the document being printed is in one of these formats and send the document directly to the printer saving the time to convert it to PS or PCL.

The first process is to analyze the information returned from the printer in industry standard public MIBs to determine if the printer supports PS, PCL 5 or 6 and what native file formats are supported. The below workflow will be used to determine this information

The benefits of the disclosed embodiments include:
Reducing image production device specific jobs from an automated system when the print supports the raw document type.
Reducing time in configuring the system to understand what PDLs an image production device supports.
Same technology can be used to redirect PDL files to an alternative image production device.

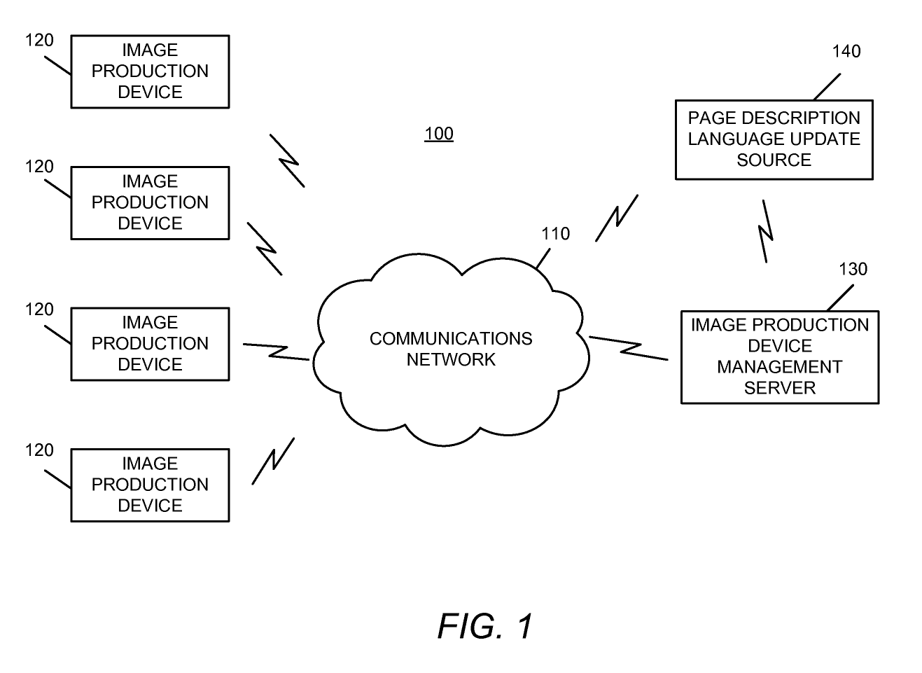

FIG. 1 is an exemplary diagram of an image production device network 100 in accordance with one possible embodiment of the disclosure. The image production device network 100 may one or more image production devices 120, an image production device management server 130, and one or more page description language update source 140 connected through the communications network 110.

The image production devices 120 may be one of or a combination of a copier, a printer, a facsimile device, and a multi-function device, for example. The one or more page description language update source 140 may be any commercial or private source using a server, computer, computer-readable medium, or other processing device or medium that may provide the ability to update page description languages. Although the connections in FIG. 1 are shown as a wireless configuration, one or more of these connections may also be wired.

Communications network 110 may represent any communications network used to communicate with other entities, including the Internet, an intranet, a radio network, a local area network, a wide area network, a wireless network, etc. The image production device management server 130 may be any server, computer, processing device, personal digital assistant (PDA), or other similar device capable of managing image production devices 120. The one or more remote devices 130 may represent any device that is capable of receiving and displaying (or playing) documents and messages, such as an e-paper device, an e-reader device, a PDA, wireless telephone phone, computer, server, processing device, display, or MP3 player.

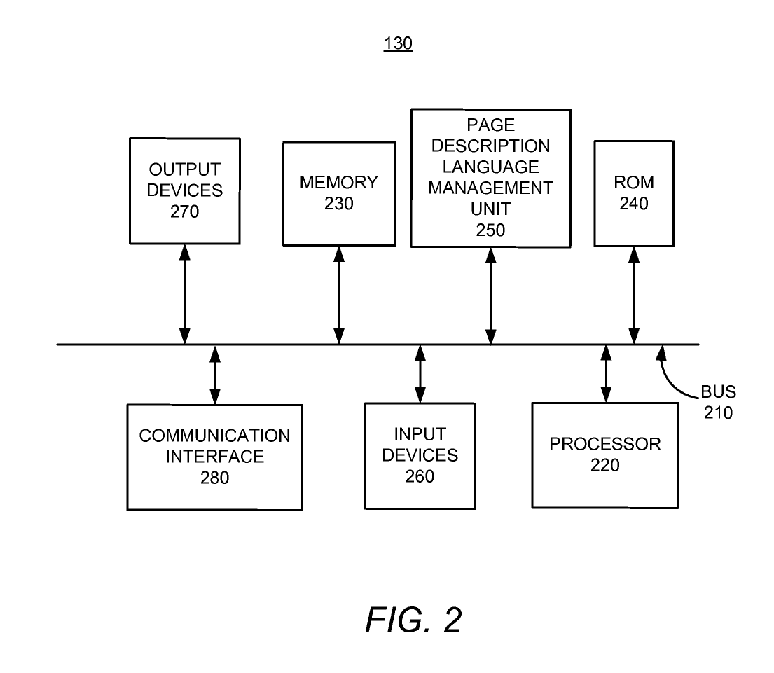

FIG. 2 is an exemplary block diagram of the image production device management server 130 in accordance with one possible embodiment of the disclosure. The exemplary image production device management server 130may include bus 210, processor 220, memory 230, read only memory (ROM) 240, page description language management unit 250, input devices 260, output devices 270, and communication interface 280. Bus 210 may permit communication among the components of the image production device management server 130.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also represent any storage device that may include any type of media, such as, for example, magnetic or optical recording media and its corresponding drive.

Input devices 260 may include one or more conventional mechanisms that permit a user to input information to the image production device management server 130, such as a keyboard, a mouse, a pen, a voice recognition device, etc. Output devices 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the image production device management server 130 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the image production device management server 130, communication interface 280 may not be included in the exemplary image production device management server 130 when the page description language detection process is implemented completely within the image production device management server 130.

The image production device management server 130 may perform such functions in response to processor 220 by executing sequences of instructions contained in a computer-readable medium, such as, for example, memory 230, a magnetic disk, or an optical disk. Such instructions may be read into memory 230 from another computer-readable medium, such as a storage device, or from a separate device via communication interface 280.

The image production device network 100 and the image production device management server 130 illustrated in FIGS. 1 and 2 and the related discussion are intended to provide a brief, general description of a suitable computing environment in which the disclosure may be implemented. Although not required, the disclosure will be described, at least in part, in the general context of computer-executable instructions, such as program modules, being executed by the image production device management server 130, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

For illustrative purposes, the operation of the page description language management unit 250 and the automatic page description languages detection process will be described below in relation to the block diagrams shown in FIGS. 1-2.

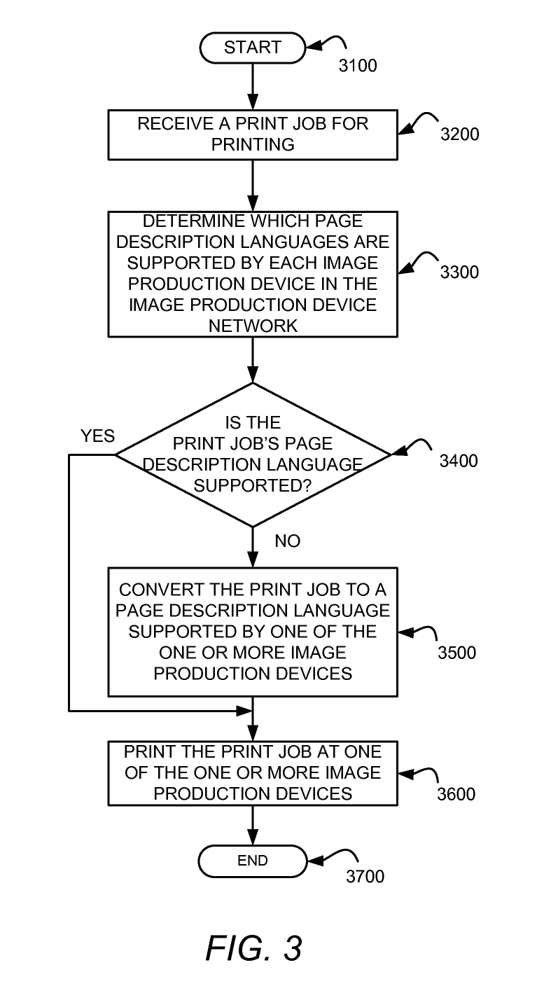

FIG. 3 is a flowchart of an exemplary automatic page description languages detection process in accordance with one possible embodiment of the disclosure. The process may begin at step 3100 and may continue to step 3200 where the page description language management unit 250 may receive a print job for printing through the communication interface 280. At step 3300, the page description language management unit 250 may determine which page description languages are supported by each image production device 120 in the image production device network 100. The page description languages may include PostScript, Portable Document Format, Page Command Language 5, Page Command Language 6, Extensible Markup Language Paper Specification, Tagged Image File Format, or other known or future-developed page description language, for example.

At step 3400, the page description language management unit 250 may determine if the print job's page description language is supported by one or more image production devices in the image production device network. If the print job's page description language is supported by one or more image production devices 120 in the image production device network 100, the process may go to step 3600 where the page description language management unit 250 may print the print job at one of the one or more image production devices 120 using the print jobs page description language. The process may then go to step 3700 and end.

If the print job's page description language is not supported by one or more image production devices 120 in the image production device network 100, the process may go to step 3500 where the page description language management unit 250 may convert the print job to a page description language supported by one of the one or more image production devices 120. The page description language to which the print job is converted may include PostScript, Portable Document Format, Page Command Language 5, Page Command Language 6, Extensible Markup Language Paper Specification, and Tagged Image File Format, or other known or future-developed page description language, for example. At step 3600, the page description language management unit 250 may print the print job at the one of the one or more image production devices 120 using the supported page description language. The process may then go to step 3700 and end.

The page description language management unit 250 may receive an update to one or more page description language, and may then update the page description language. The page description language management unit 250 may also automatically detect whether a page description language update is available, may download the page description language update, and may then update the page description language.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for automatically detecting page description languages supported by image production devices in an image production device network, comprising:
receiving a print job for printing;
determining which page description languages are supported by each image production device in the image production device network;
determining if the print job's page description language is supported by one or more image production devices in the image production device network, wherein if the print job's page description language is supported by one or more image production devices in the image production device network,
printing the print job at one of the one or more image production devices using the print jobs page description language, wherein the print job's page description language is not supported by one or more image production devices in the image production device network,
converting the print job to a page description language supported by one of the one or more image production devices; and
printing the print job at the one of the one or more image production devices using the supported page description language.

2. The method of claim 1, further comprising:
receive an update to one or more page description language; and
update the page description language.

3. The method of claim 1, wherein at least one of the page description languages is one of PostScript, Portable Document Format, Page Command Language 5, Page Command Language 6, Extensible Markup Language Paper Specification, and Tagged Image File Format.

4. The method of claim 1, further comprising:
automatically detecting whether a page description language update is available; and
downloading the page description language update.

5. The method of claim 1, wherein the page description language to which the print job is converted is one of PostScript, Portable Document Format, Page Command Language 5, Page Command Language 6, Extensible Markup Language Paper Specification, and Tagged Image File Format.

6. The method of claim 1, wherein the image production devices are one of or a combination of a copier, a printer, a facsimile device, and a multi-function device.

7. The method of claim 1, wherein the image production device management server is one of a server, computer, processing device, personal digital assistant (PDA)

8. An image production device management server that automatically detects page description languages supported by image production devices in an image production device network, comprising:
a communication interface; and
a page description language management unit that receives a print job for printing through the communication interface, determines which page description languages are supported by each image production device in the image production device network, determines if the print job's page description language is supported by one or more image production devices in the image production device network, wherein if the print job's page description language is supported by one or more image production devices in the image production device network, the page description language management unit prints the print job at one of the one or more image production devices using the print jobs page description language, wherein if the print job's page description language is not supported by one or more image production devices in the image production device network, the page description language management unit converts the print job to a page description language supported by one of the one or more image production devices, and prints the print job at the one of the one or more image production devices using the supported page description language.

9. The image production device management server of claim 8, wherein the page description language management unit receives an update to one or more page description language, and updates the page description language.

10. The image production device management server of claim 8, wherein at least one of the page description languages is one of PostScript, Portable Document Format, Page Command Language 5, Page Command Language 6, Extensible Markup Language Paper Specification, and Tagged Image File Format.

11. The image production device management server of claim 8, wherein the page description language management unit automatically detects whether a page description language update is available, and downloads the page description language update.

12. The image production device management server of claim 8, wherein the page description language to which the print job is converted is one of PostScript, Portable Document Format, Page Command Language 5, Page Command Language 6, Extensible Markup Language Paper Specification, and Tagged Image File Format.

13. The image production device management server of claim 8, wherein the image production devices are one of or a combination of a copier, a printer, a facsimile device, and a multi-function device.

14. The image production device management server of claim 8, wherein the image production device management server is one of a server, computer, processing device, personal digital assistant (PDA).

15. A non-transient computer-readable medium storing instructions for controlling a computing device for automatically detecting page description languages supported by image production devices in an image production device network, the instructions comprising:
receiving a print job for printing;
determining which page description languages are supported by each image production device in the image production device network;
determining if the print job's page description language is supported by one or more image production devices in the image production device network, wherein if the print job's page description language is supported by one or more image production devices in the image production device network,
printing the print job at one of the one or more image production devices using the print jobs page description language, wherein if the print job's page description language is not supported by one or more image production devices in the image production device network,
converting the print job to a page description language supported by one of the one or more image production devices; and
printing the print job at the one of the one or more image production devices using the supported page description language.

16. The non-transient computer-readable medium of claim 15, further comprising:
receive an update to one or more page description language; and
update the page description language.

17. The non-transient computer-readable medium of claim 15, wherein at least one of the page description languages is one of PostScript, Portable Document Format, Page Command Language 5, Page Command Language 6, Extensible Markup Language Paper Specification, and Tagged Image File Format.

18. The non-transient computer-readable medium of claim 15, further comprising:
automatically detecting whether a page description language update is available; and
downloading the page description language update.

19. The non-transient computer-readable medium of claim 15, wherein the page description language to which the print job is converted is one of PostScript, Portable Document Format, Page Command Language 5, Page Command Language 6, Extensible Markup Language Paper Specification, and Tagged Image File Format.

20. The non-transient computer-readable medium of claim 15, wherein the image production devices are one of or a combination of a copier, a printer, a facsimile device, and a multi-function device.

21. The non-transient computer-readable medium of claim 15, wherein the image production device management server is one of a server, computer, processing device, personal digital assistant (PDA).
